(19) United States
(12) Patent Application Publication
(10) Pub. No.: US 2024/0042522 A1
(43) Pub. Date: Feb. 8, 2024

(54) INDETERMINATE COPPER MATERIALS FOR ELECTROLYTIC COPPER FOIL AND METHOD FOR PREPARING THE SAME

(71) Applicant: LS CABLE & SYSTEM LTD., Anyang-si, Gyeonggi-do (KR)

(72) Inventors: Chul Hyun KIM, Anyang-si, Gyeonggi-do (KR); Sangyum KIM, Anyang-si, Gyeonggi-do (KR); Min Su KANG, Gunpo-si, Gyeonggi-do (KR); Hyun Ho YOO, Yongsan-gu, Seoul (KR)

(21) Appl. No.: 18/266,444

(22) PCT Filed: Apr. 22, 2022
(86) PCT No.: PCT/KR22/05772

§ 371 Date: Jun. 9, 2023

(30) Foreign Application Priority Data
Sep. 3, 2021 (KR) 10-2021-0117350
Oct. 8, 2021 (KR) 10-2021-0134003

(51) Int. Cl. B22F 9/08; B22F 1/05

(52) U.S. Cl. CPC B22F 9/08; B22F 1/05; B22F 2301/10; B22F 2304/15

(57) ABSTRACT

Provided is an indeterminate copper material for electrolytic copper foil and a preparation method thereof. Specifically, the present disclosure relates to an indeterminate copper material for electrolytic copper foil, which exhibits excellent dissolution performance when dissolved in an electrolyte to manufacture electrolytic copper foil, contributes to securing work stability during the manufacture of electrolytic copper foil, and is simple to prepare, thereby reducing manufacturing costs, and a preparation method thereof.

### CROSS-REFERENCE TO RELATED APPLICATIONS

The present application is a National Stage of International Application No. PCT/KR2022/005772 filed on Apr. 22, 2022, which claims the benefit of Korean Patent Application No. 10-2021-0117350, filed on Sep. 3, 2021, and Korean Patent Application No. 10-2021-0134003, filed on Oct. 8, 2021 with the Korean Intellectual Property Office, the entire contents of which are hereby incorporated by reference.

### FIELD

The present disclosure relates to an indeterminate copper material for electrolytic copper foil and a preparation method thereof. Specifically, the present disclosure relates to an indeterminate copper material for electrolytic copper foil, which exhibits excellent dissolution performance when dissolved in an electrolyte to manufacture electrolytic copper foil, contributes to securing work stability during the manufacture of electrolytic copper foil, and is simple to prepare, thereby reducing manufacturing costs, and a preparation method thereof.

### BACKGROUND

An electrolytic copper may be manufactured by a continuous plating method of obtaining precipitated copper in the form of copper foil by rotating a large titanium drum as a cathode in an electrolyte, e.g., a copper sulfate solution, at a lower speed, and is used, for example, for a copper-laminated plate for a printed circuit board or a building material, and particularly, a negative plate of a secondary battery.

FIG. 1 is a flowchart of a process of preparing a raw material of a linear copper material for electrolytic copper foil of the related art. FIG. 2 is a photograph of the appearance and microstructure of a cut copper wire rod manufactured during preparation of a raw material of a linear copper material for electrolytic copper foil of the related art.

As shown in FIG. 1, a raw material of a linear copper material for electrolytic copper foil may be prepared by a method including supplying a raw material such as an electrolytic copper or a copper scrap, forming a wire rod of the raw material by casting, casting and rolling, or casting, rolling and wire drawing, and cleaning and cutting the wire rod. The electrolytic copper foil may be manufactured by dissolving the cut linear copper material, which is a raw material of electrolytic copper foil, in a sulfuric acid solution serving as an electrolyte.

In a preparation method of electrolytic copper foil of the related art, a cut copper wire rod, which is a linear copper material as shown in FIG. 2, is used as a raw material of electrolytic copper foil. The cut linear copper material is prepared by rolling, wire drawing, and cutting and thus is exposed to oils such as rolling oil and wire drawing oil during rolling and wire drawing. Accordingly, a cleaning process should be performed to remove grease. Therefore, the preparation method is complicated, thus increasing manufacturing costs of electrolytic copper foil.

Generally, the cut linear copper material is prepared in a form having a size of 2 to 4 mm in diameter and 30 to 100 mm in length to improve dissolution performance for the electrolyte. In this case, the cut linear copper material is likely to leak through a bottom of a plate which is provided below a water tank of a dissolver and in which a hole having a diameter of 10 mm is formed to circulate the electrolyte or supply air during dissolution of the electrolyte, thereby reducing workability.

Furthermore, the linear copper material is formed in a size of about 5 μm on average through grain refinement after continuous casting, rolling, and wire drawing, as shown in FIG. 2. Oxidation, i.e., passivation, of a surface of the linear copper material may accelerate due to high grain boundary density, thereby reducing dissolution performance for the electrolyte.

Therefore, there is an urgent need for a copper material for electrolytic copper foil, which exhibits excellent dissolution performance when dissolved in an electrolyte to manufacture electrolytic copper foil, contributes to securing work stability during the manufacture of the electrolytic copper foil, and is simple to prepare, thereby reducing manufacturing costs, and a preparation method thereof.

### SUMMARY

The present disclosure is directed to providing an indeterminate copper material for electrolytic copper foil, which exhibits excellent dissolution performance when dissolved in an electrolyte, and a preparation method thereof.

The present disclosure is also directed to providing an indeterminate copper material that contributes to securing work stability during manufacture of electrolytic copper foil and that is simple to prepare, thereby reducing manufacturing costs of electrolytic copper foil, and a preparation method thereof.

To achieve these objects, the present disclosure provides an indeterminate copper material for electrolytic copper foil, wherein an average grain size is in a range of 50 to 300 μm.

Further, the present disclosure provides the indeterminate copper material, wherein bulk density is in a range of 1.0 to 3.0 g/cm³ and is defined by the following Equation 1:

bulk density (g/cm³)=total mass of indeterminate copper material (g)/1000 cm³, [Equation 1]

wherein total mass of indeterminate copper material denotes total mass of the indeterminate copper material filling a cubic box having a size of 10 cm×10 cm×10 cm in width, length and height.

Meanwhile, the present disclosure provides the indeterminate copper material, wherein a longest axis among long axes on a cross section of the indeterminate copper material is 10 mm or more, and a shortest axis among short axes on the cross section is 5 mm or less.

Further, the present disclosure provides the indeterminate copper material, wherein the longest axis is in a range of 10 to 75 mm, and the shortest axis is in a range of 1 to 5 mm.

Meanwhile, the present disclosure provides a preparation method of the indeterminate copper material, comprising: a) supplying a copper raw material; b) melting the copper raw material; and c) preparing an indeterminate copper material by melting the copper raw material into molten copper and casting the molten copper.

Further, the present disclosure provides the preparation method, wherein c) comprises preparing an indeterminate copper material by dispersing the molten copper, which is melted from the copper raw material, in the form of particles and cooling the molten copper while participating the molten copper in water contained in a water tank.

Meanwhile, the present disclosure provides the preparation method, wherein c) comprises preparing the indeterminate copper material by dispersing the molten copper, which is melted from the copper raw material, in the form of particles by dropping the molten copper from a molten metal nozzle to an impaction plate on the water tank containing water, and cooling the molten copper while precipitating the molten copper in the water in the water tank.

Further, the present disclosure provides the preparation method, wherein a melting temperature of the molten copper is in a range of 1,090 to 1,400° C.

Meanwhile, the present disclosure provides the preparation method, wherein a distance between a discharge port of the molten metal nozzle and an upper surface of the impaction plate is in a range of 0.3 to 1.0 m.

Further, the present disclosure provides the preparation method of claim 5, wherein oxygen content of the molten copper is in a range of 20 to 1,000 ppm.

The indeterminate copper material for electrolytic copper foil according to the present disclosure achieves an excellent effect, which exhibits excellent dissolution performance, such as a high dissolution rate and a high dissolution content, when dissolved in an electrolyte by controlling a specific bulk density, grain size and shape of the indeterminate copper material.

Further, the indeterminate copper material for electrolytic copper foil according to the present disclosure achieves an excellent effect, which contributes to securing work stability during manufacture of electrolytic copper foil and that is simple to prepare, since rolling, wire drawing, and cutting are not needed to manufacture the indeterminate copper material, thereby reducing manufacturing costs of electrolytic copper foil.

### BRIEF DESCRIPTION OF THE DRAWINGS

FIG. 1 is a flowchart of a process of preparing a linear copper material for electrolytic copper foil of the related art;

FIG. 2 is a photograph of the appearance of microstructure of a linear copper material for electrolytic copper foil of the related art;

FIG. 3 is a flowchart of a process of preparing an indeterminate copper material for electrolytic copper foil according to the present disclosure;

FIG. 4 is a photograph of the appearance and microstructure of an indeterminate copper material prepared by the process of FIG. 3;

FIG. 5 is a schematic view of a casting device used in the process of preparing an indeterminate copper material for electrolytic copper foil of FIG. 3; and

FIG. 6 illustrates a form of a copper material filling a cubic acrylic box to measure bulk density.

### DETAILED DESCRIPTION

Hereinafter, embodiments of the present disclosure will be described in detail with reference to the accompanying drawings. The present disclosure is, however, not limited thereto and may be embodied in many different forms. Rather, the embodiments set forth herein are provided so that this disclosure may be thorough and complete and fully convey the scope of the disclosure to those skilled in the art.

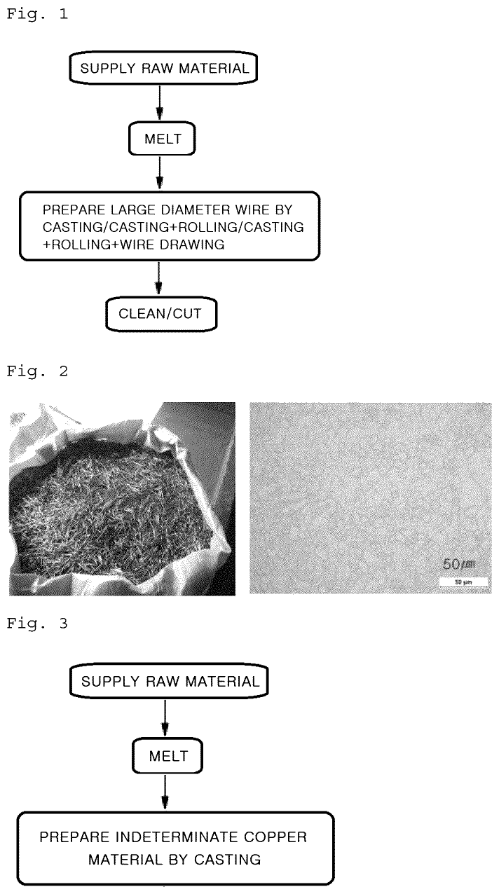

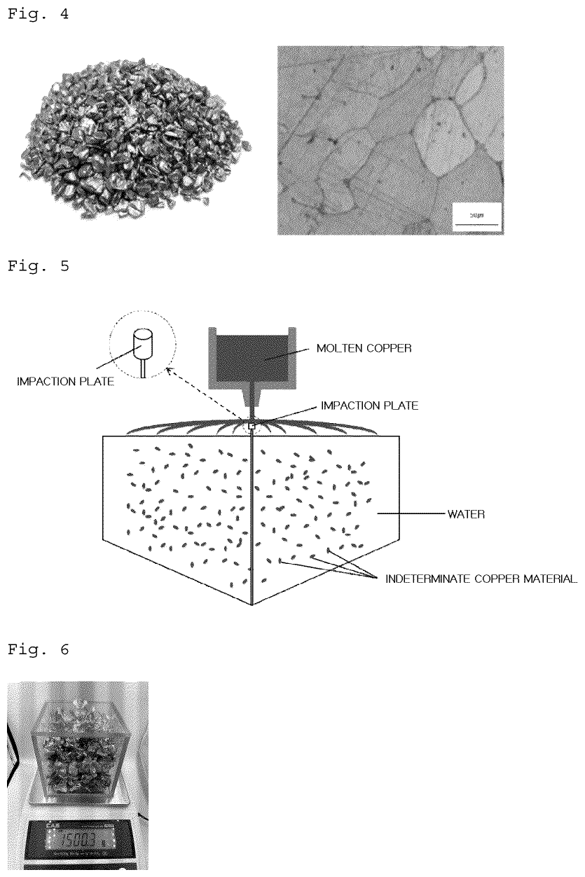

FIG. 3 is a flowchart of a process of preparing an indeterminate copper material for electrolytic copper foil according to the present disclosure. FIG. 4 is a photograph of the appearance and microstructure of an indeterminate copper material prepared by the process of FIG. 3. FIG. 5 is a schematic view of a casting device used in the process of preparing an indeterminate copper material for electrolytic copper foil of FIG. 3. FIG. 6 illustrates a form of a copper material filling a cubic acrylic box to measure bulk density.

As shown in FIG. 3, the indeterminate copper material for electrolytic copper foil may be prepared by a preparation method including the following operations a) to c):
a) supplying a raw material such as an electrolytic copper or scrap,
b) melting the supplied raw material, and
c) preparing an indeterminate copper material by casting the melted raw material.

Operation C) above may be performed using the casting device of FIG. 5. As shown in FIG. 5, an indeterminate copper material may be prepared by dropping refined copper, which is melted at 1,090° C. or more, and preferably, 1,090 to 1,400° C., from a molten metal nozzle onto an impaction plate on a water tank containing water. The dropped molten copper is dispersed in all directions in the form of indeterminate particles having no specific shape due to impact when colliding against the impaction plate and is cooled while being precipitated in the water in the water tank.

Here, when a molten temperature of the molten copper is less than 1,090° C., the molten copper may coagulate earlier than expected, thus blocking a discharge port of the molten metal nozzle or causing the dropped copper to be fused on the impaction plate, whereas when the molten temperature of the molten copper is greater than 1,400° C., the molten copper dispersed in the form of particles in all directions when dropped on the impaction plate may be fused on the impaction plate, thereby forming an excessively coarse copper material.

In addition, a size of an indeterminate copper material to be generated may be controlled by adjusting a distance between the discharge port of the molten metal nozzle through which the molten copper is discharged and an upper surface of the impaction plate to be 0.3 to 1.5 m from the bottom of a molten metal tank containing the molten copper.

Here, when the distance between the discharge port of the molten metal nozzle and the upper surface of the impaction plate is less than 0.3 m, the molten copper may not be sufficiently scattered on the impaction plate, thus forming an excessively coarse copper material, whereas when the distance between the discharge port of the molten metal nozzle and the upper surface of the impaction plate is greater than 1.5 m, the molten copper may be scattered in an extremely minute form on the impaction plate, thus forming an extremely minute indeterminate copper material.

Furthermore, an oxygen content of a molten metal of the molten copper may be adjusted to 20 to 1,000 ppm. Here, when the oxygen content of the molten metal is less than 20 ppm, a large amount of hydrogen may be introduced into the molten metal, thus making it difficult to control a form of an indeterminate copper material formed of the scattered molten copper, whereas when the oxygen content of the molten metal is greater than 1,000 ppm, a large amount of oxides may be generated during the coagulation of the indeterminate copper material through cooling, thus making it difficult to control the form of the indeterminate copper material.

An indeterminate copper material for electrolytic copper foil of the present disclosure, which is prepared by the preparation method of the above-described embodiment, may be understood to mean a copper material having an indeterminate shape that cannot be defined as a specific shape such as a linear or circular shape.

Meanwhile, electrolytic copper foil may be manufactured by dissolving the indeterminate copper material prepared as described above in a sulfuric acid electrolyte. As described above, unlike a linear copper material of the related art, rolling, wire drawing, and cutting are not needed to manufacture an indeterminate copper material, and especially, rolling oil and wire drawing oil, which are needed for rolling and wire drawing, are not used. Thus, a process may be very simplified, thereby greatly reducing manufacturing costs of electrolytic copper foil.

Here, as shown in FIG. 4, the indeterminate copper material has a large average grain size of 50 to 300 μm, and preferably, a range of 150 to 250 μm, and thus has a low grain boundary density, thus securing sufficient dissolution performance for an electrolyte due to surface delay.

In contrast, the linear copper material of the related art shown in FIG. 2 has a small average grain size of less than 50 μm and thus has a high grain boundary density, thus reducing dissolution performance for an electrolyte due to acceleration of the passivation of a surface of the linear copper material.

The large grain size of the indeterminate copper material may be achieved by quickly cooling the molten copper in water as shown in FIG. 5 without rolling and wire drawing, unlike the linear copper material of the related art.

Here, the average grain sizes may be measured by inputting photographs of a microstructure of the indeterminate copper material and a microstructure of the linear copper material, which are taken by an optical microscope or an electron microscope, into general-purpose software such as Image Analyzer but may be measured in other various ways known to those of ordinary skill in the art.

In addition, the indeterminate copper material may be in the form of indeterminate particles having an indeterminate shape as shown in FIG. 4 and have bulk density of 1.0 to 3.0 g/cm³. The inventors of the present application have completed the present disclosure by experimentally confirming that when a prepared indeterminate copper material had a specific grain size and preferably additionally had specific bulk density, the indeterminate copper material exhibited improved dissolution performance, such as a high dissolution rate and a high dissolution content, when dissolved in an electrolyte.

Here, the bulk density may be understood to mean total mass of the copper material relative to the volume of a cubic box having a size of 10 cm×10 cm×10 cm in width, length, and height, and may be defined by Equation 1 below.

bulk density (g/cm³)=total mass of copper material (g)/1000 cm³, [Equation 1]
wherein “total mass of copper material” denotes total mass of a copper material filling a cubic box having a size of 10 cm×10 cm×10 cm in width, length and height.

The total mass of the copper material may be calculated by dropping the copper material into a cubic acrylic box having a size of 10 cm×10 cm×10 cm in width, length, and height from a height of 5 cm from the top of the cubic acrylic box, so that the copper material may fill up to the top of the cubic acrylic box and a cover of the cubic acrylic box may be completely closed. The width, length, and height of the cubic acrylic box were based dimensions of the inside of the box, and in an embodiment of the present disclosure, an acrylic box having a thickness of 5 mm was used but a material and thickness of the box are not particularly limited provided that a cubic shape of the box can be maintained.

In particular, when the bulk density of the indeterminate copper material is less than 1.0 g/cm³, a surface area of the indeterminate copper material in contact with an electrolyte may increase but the amount of copper actually dissolved in the electrolyte may be insufficient, whereas when the bulk density is greater than 3.0 g/cm³, the amount of copper actually dissolved in the electrolyte may be sufficient but a surface area of the indeterminate copper material in contact with the electrolyte may be less than a reference level, thereby greatly reducing a dissolution rate.

In addition, a longest axis among long axes on a cross section of the indeterminate copper material may be 10 mm or more, and preferably 10 to 75 mm, and a shortest axis among short axes on the cross section of the indeterminate copper material may be 5 mm or less, and preferably 1 to 5 mm.

When the longest axis is less than 10 mm, the copper material may leak through a bottom of a plate which is located below a water tank containing the electrolyte and in which a hole having a diameter of 10 mm is formed to circulate the electrolyte and supply air, whereas when the longest axis is greater than 75 mm, the surface area of the copper material may not be sufficient, thus greatly reducing dissolution performance for the electrolyte. When the shortest axis is greater than 5 mm, a specific surface area of the copper material may be insufficient, thus greatly reducing dissolution performance for the electrolyte.

Here, the longest and shortest axes of the indeterminate copper material may be measured using a tool such as a vernier caliper but a type of tool is not particularly limited as long as a length can be measured by the tool.

### Example

### 1. Preparation Examples of Copper Material

Indeterminate copper materials of examples 1 to 3 each having characteristics shown in Table 1 below were prepared using the casting device of FIG. 5 by adjusting a temperature of a molten metal of molten copper and a distance to an impaction plate from a discharge port of a molten metal nozzle through which the molten copper is discharged.

For comparison with the above-described examples, linear copper materials of comparative examples 1 to 3 were prepared by casting, rolling and wire-drawing and cleaning and cutting a copper raw material.

TABLE 1

| | Example | Example | Example | Comparative | Comparative | comparative |
|---|---|---|---|---|---|---|
| | 1 | 2 | 3 | example 1 | example 2 | example 3 |
| average grain | 189 | 195 | 177 | 5.8 | 7.0 | 10.4 |
| size (μm) | | | | | | |
| size (shortest | 1 × 50 | 3 × 50 | 5 × 50 | 3.1 (diameter) × | 4.2 (diameter) × | 8.0 (diameter) × |
| axis × longest | | | | 80 (length) | 80 (length) | 90 (length) |
| axis (mm)) | | | | | | |
| bulk density | 1.88 | 1.63 | 2.48 | 3.89 | 3.95 | 3.87 |
| (g/cm³) | | | | | | |

### 2. Evaluation of Dissolution Performance of Copper Material

Copper materials according to examples and comparative examples were immersed in 1L of an 80° C. sulfuric acid solution having a density of 150 g/L for 48 hours. Thereafter, the weight of each sample was measured and a meltage of each sample was calculated and recorded in Table 2 below.

TABLE 2

| | Example | Example | Example | Comparative | Comparative | comparative |
|---|---|---|---|---|---|---|
| classification | 1 | 2 | 3 | example 1 | example 2 | example 3 |
| weight (g) before | 121.0 | 122.1 | 120.3 | 124.0 | 125.4 | 121.1 |
| dissolved | | | | | | |
| weight (g) after | 108.3 | 113.6 | 113.8 | 119.6 | 121.5 | 120.4 |
| dissolved | | | | | | |
| meltage (g/L) | 12.7 | 8.5 | 6.5 | 4.4 | 3.9 | 0.7 |

As shown in Table 2, it was confirmed that dissolution performance such as a dissolution rate and a meltage of the indeterminate copper materials of examples 1 to 3 each having a certain grain size and a shape of a specific size and accurately controlled bulk density was greatly improved.

In contrast, it was confirmed that in the case of the existing linear copper materials of comparative examples 1 to 3, bulk density was greater than a reference level and thus a surface area in contact with an electrolyte was less than a reference level, thereby greatly reducing a dissolution rate, and grain boundary density was high due to a small average grain size, thus accelerating surface passivation and reducing dissolution performance for the electrolyte.

While the present disclosure has been described above with respect to exemplary embodiments thereof, it would be understood by those of ordinary skilled in the art that various changes and modifications may be made without departing from the technical conception and scope of the present disclosure defined in the following claims. Thus, it is clear that all modifications are included in the technical scope of the present disclosure as long as they include the components as claimed in the claims of the present disclosure.

1. An indeterminate copper material for electrolytic copper foil, wherein an average grain size is in a range of 50 to 300 μm.

2. The indeterminate copper material of claim 1, wherein bulk density is in a range of 1.0 to 3.0 g/cm³ and is defined by the following Equation 1:
bulk density (g/cm³)=total mass of indeterminate copper material (g)/1000 cm³, [Equation 1]
wherein total mass of indeterminate copper material denotes total mass of the indeterminate copper material filling a cubic box having a size of 10 cm×10 cm×10 cm in width, length and height.

3. The indeterminate copper material of claim 1, wherein a longest axis among long axes on a cross section of the indeterminate copper material is 10 mm or more, and
a shortest axis among short axes on the cross section is 5 mm or less.

4. The indeterminate copper material of claim 3, wherein the longest axis is in a range of 10 to 75 mm, and the shortest axis is in a range of 1 to 5 mm.

5. A preparation method of the indeterminate copper material of claim 1, comprising:
a) supplying a copper raw material;
b) melting the copper raw material; and
c) preparing an indeterminate copper material by melting the copper raw material into molten copper and casting the molten copper.

6. The preparation method of claim 5, wherein c) comprises preparing an indeterminate copper material by dispersing the molten copper, which is melted from the copper raw material, in the form of particles and cooling the molten copper while participating the molten copper in water contained in a water tank.

7. The preparation method of claim 6, wherein c) comprises preparing the indeterminate copper material by dispersing the molten copper, which is melted from the copper raw material, in the form of particles by dropping the molten copper from a molten metal nozzle to an impaction plate on the water tank containing water, and cooling the molten copper while precipitating the molten copper in the water in the water tank.

8. The preparation method of claim 5, wherein a melting temperature of the molten copper is in a range of 1,090 to 1,400° C.

9. The preparation method of claim 7, wherein a distance between a discharge port of the molten metal nozzle and an upper surface of the impaction plate is in a range of 0.3 to 1.5 m.

10. The preparation method of claim 5, wherein oxygen content of the molten copper is in a range of 20 to 1,000 ppm.

11. The electrolytic copper foil prepared from the indeterminate copper material for electrolytic copper foil according to claim 1.

12. A method for preparing electrolytic copper foil, comprising:
a) resolving the indeterminate copper material for electrolytic copper foil according to claim 1 in an electrolyte,
b) rotating a drum as a cathode in the electrolyte in order that copper (Cu) sticks to the drum, and
c) obtaining copper foil from the drum to which the copper (Cu) sticks.
